(19) United States
(12) Patent Application Publication
(10) Pub. No.: US 2009/0039215 A1
(43) Pub. Date: Feb. 12, 2009

(54) MICROPHONE BOOM MOUNT AND ADAPTER

(75) Inventors: David Hilderman, Victoria (CA); Damon Langlois, Victoria (CA)

Correspondence Address: CANTOR COLBURN, LLP, 20 Church Street, 22nd Floor, Hartford, CT, 06103, US

(73) Assignee: THE TC GROUP A/S, RISSKOV (DK)

(21) Appl. No.: 12/089,496

(22) PCT Filed: Oct. 3, 2006
(86) PCT No.: PCT/DK06/50051

§ 371 Date: Aug. 27, 2008

(30) Foreign Application Priority Data
Jan. 19, 2006 (DK) 2006 00076

(51) Int. Cl. F16M 11/04

(52) U.S. Cl. 248/187.1

(57) ABSTRACT

Disclosed is an adapter comprising a threaded pin and a base, wherein said threaded pin comprises a threading corresponding to an industry standard microphone boom mount threading, the invention further relating to an assembly comprising a microphone boom and a support, wherein the assembly is assembled by a sliding-slot and a corresponding mechanical arrangement fitting into the sliding slot by a sliding movement between the microphone boom and the support, and wherein the assembly further comprises a further mechanical releasable lock arrangement for mutual fixation of the microphone boom and the support in the slide direction of the sliding slot.

### FIELD OF THE INVENTION

The present invention relates to the field of microphone stands, in particular an adapter, an assembly and a method of mounting a microphone boom to a support.

### BACKGROUND OF THE INVENTION

In the field of stage performance of any kind as well as in several other fields, microphone stands are indispensable and form part of the standard equipment of any performer and sound technician, in any economical, professional or quality class. An extremely common microphone stand design comprises a vertical shaft, mainly for elevating the microphone, and a microphone boom mounted on top of it, mainly for removing the microphone horizontally from the stand and facilitating free positioning of the microphone, both vertically and horizontally. The vertical shaft is typically supported by a tripod base or other supporting arrangement. As regards the mounting of the microphone boom on the shaft, almost all mountings comprise the top of the shaft being threaded on the outside, and the microphone boom comprising a vertical socket correspondingly threaded on the inside. Regarding the threading, two industry standards exist, i.e. a North American standard of ⅝″ thickness and 27 threads per inch, and a European standard of ⅜″ thickness and 16 threads per inch. The microphone boom is typically of a considerable length in order to allow as much freedom in relation to the positioning and the distance between a performer and the microphone stand as possible. Moreover, the microphone boom is typically mounted in a predominantly horizontal direction, as opposed to vertical. When assembling a microphone stand, in particular when mounting the microphone boom on the shaft, it is thus inconvenient to screw the boom on to the shaft by rotating the boom socket, as it typically requires the considerably long, substantially horizontal boom to be rotated. Instead the boom is typically held above the shaft, the shaft lifted from the ground and the shaft rotated, thereby avoiding having the boom swinging round and round while fastening the socket.

For some applications, however, a microphone boom has to be mounted on other kinds of support than a simple, vertical shaft. The fact that only two significant microphone boom mounting standards exist, i.e. the North American and the European as described above, only strengthens the motivation for providing alternatives to the conventional shaft or for providing different applications for microphone booms as anyone can easily obtain a suitable microphone boom, if not in possession of one already. However, some of the alternative stands and other applications, on which a microphone boom is to be mounted using the standard threaded joint, may not be as easily lifted and rotated as is common praxis when mounting a boom on a conventional shaft, as described above. Hence, for some applications, the use of the industry standard threaded joints in order to allow the use of readily available booms forces the boom to be swung round and round when fastening it.

It is an object of the present invention to provide a method and a mount for mounting a possibly completely conventional microphone boom on a support without having to rotate the boom itself.

### SUMMARY OF THE INVENTION

According to an embodiment of the invention, the microphone boom and the support, which may e.g. comprise a microphone stand or e.g. an audio monitor fastened on a microphone stand, may be mutually attached by means of a slide and lock connection. This connection is advantageous compared to traditional torque mounting of microphone booms on a support as such torque mounting typically requires that the support can be rotated at the time of mounting and as rotation of the complete boom may be quite inconvenient if not completely impossible.

The invention facilitates an advantageous mounting of a microphone boom on a support by a simple slide and lock arrangement, and fixation may more or less be obtained in one straight movement which may be performed quite fast. The further mechanical releasable locking arrangement may be established in several different ways as long as they facilitate the other part of the assembly being slid into the sliding slot and then being mechanically fixated to prevent sliding within the sliding slot, and thereby fixating the two parts of the assembly mutually.

A monitor is broadly understood as an active loudspeaker, comprising both an amplifier and a loudspeaker unit. Monitors may typically be defined as a stand-alone speaker which may often, e.g., be used by a performing artist.

The present invention relates to an adapter 40 comprising a threaded pin 41 and a base 42 wherein said threaded pin comprises a threading corresponding to an industry standard microphone boom mount threading 31.

According to the present invention, two major industry standard boom mount threadings exist. They are a North American standard of ⅝″ thickness and 27 threads per inch, and a European standard of ⅜″ thickness and 16 threads per inch. By providing an adapter for such standards, it is very likely that almost any microphone boom can be fitted by means of the adapter of the present invention. When said base 42 fits within a sliding slot 50 of a support 26, 120, an advantageous embodiment of the present invention is obtained.

When said base fits within said sliding slot of said support in a sliding manner, an advantageous embodiment of the present invention is obtained.

When said support comprises a monitor 26, 120, an advantageous embodiment of the present invention is obtained.

When said support comprises a microphone stand, an advantageous embodiment of the present invention is obtained.

When said adapter comprises a lock nut 43, an advantageous embodiment of the present invention is obtained.

When said base 42 is edged, an advantageous embodiment of the present invention is obtained.

When said base 42 is round, an advantageous embodiment of the present invention is obtained.

When said adapter is a microphone boom mount adapter, an advantageous embodiment of the present invention is obtained.

When said adapter is provided together with said support, an advantageous embodiment of the present invention is obtained.

The present invention further relates to an assembly comprising a microphone boom 10, 20 and a support 26, 120, wherein said assembly is assembled by a sliding-slot 50 and a corresponding mechanical arrangement 40 fitting into said sliding slot by a sliding movement between said microphone boom and said support, and wherein said assembly further comprises a further mechanical releasable lock arrangement 70, 100, 150, 160 for mutual fixation of said microphone boom and said support in the slide direction of said sliding slot.

When said slide direction is the longitudinal direction of said sliding slot, an advantageous embodiment of the present invention is obtained.

When said sliding slot 50 is comprised by said microphone boom 10, 20, an advantageous embodiment of the present invention is obtained.

When said sliding slot is comprised by said support, an advantageous embodiment of the present invention is obtained.

When said further mechanical releasable lock arrangement is comprised by said microphone boom, an advantageous embodiment of the present invention is obtained.

When said further mechanical releasable lock arrangement is comprised by said support, an advantageous embodiment of the present invention is obtained.

When said support forms part of a microphone stand, an advantageous embodiment of the present invention is obtained.

When said support forms part of a monitor 26, 120, an advantageous embodiment of the present invention is obtained.

When said monitor is mounted on top of a microphone stand 13, 23, an advantageous embodiment of the present invention is obtained.

When said support comprises a monitor 26, 120, an advantageous embodiment of the present invention is obtained.

When said corresponding mechanical arrangement fitting into said sliding slot is integrated with said microphone boom, an advantageous embodiment of the present invention is obtained.

When said corresponding mechanical arrangement fitting into said sliding slot forms part of an adapter which is releasably attached to said microphone boom, and wherein said microphone boom comprises a conventional microphone boom, an advantageous embodiment of the present invention is obtained.

When said corresponding mechanical arrangement fitting into said sliding slot comprises a threaded pin, an advantageous embodiment of the present invention is obtained.

When said threaded pin comprises industry standard microphone mount threading, an advantageous embodiment of the present invention is obtained.

When said corresponding mechanical arrangement fitting into said sliding slot comprises an edged base 42, an advantageous embodiment of the present invention is obtained.

When said sliding-slot comprises a flange 53 which may cooperate with said corresponding mechanical arrangement 40, an advantageous embodiment of the present invention is obtained.

When said further mechanical releasable lock arrangement comprises an automatically engaging lock, an advantageous embodiment of the present invention is obtained.

When said further mechanical releasable lock arrangement comprises a manually engaged lock, an advantageous embodiment of the present invention is obtained.

When said further mechanical releasable lock arrangement comprises a pivotal lid 70, an advantageous embodiment of the present invention is obtained.

When said lid is spring-loaded, an advantageous embodiment of the present invention is obtained.

When said further mechanical releasable lock arrangement comprises a socket and plug arrangement 100, an advantageous embodiment of the present invention is obtained.

When said further mechanical releasable lock arrangement comprises a spring-loaded clip 160 or locking arm 150, an advantageous embodiment of the present invention is obtained.

When said support comprises a compartment 80 suitable for receiving said corresponding mechanical arrangement fitting into said sliding slot, an advantageous embodiment of the present invention is obtained.

When said further mechanical releasable lock arrangement forms part of said compartment 80, an advantageous embodiment of the present invention is obtained.

When said assembly can be disassembled, an advantageous embodiment of the present invention is obtained.

When said corresponding mechanical arrangement fitting into said sliding slot comprises an adapter according to any of the above, an advantageous embodiment of the present invention is obtained.

The present invention further relates to a method of mounting a microphone boom 10, 20 on a support 26, 120 whereby said microphone boom or said support comprises a sliding member 40 which is slid into a slot 50 of the other part and locked by a further locking mechanism 70, 100, 150, 160.

When said sliding member is comprised by said microphone boom, an advantageous embodiment of the present invention is obtained.

When said sliding member is comprised by said support, an advantageous embodiment of the present invention is obtained.

When said microphone boom comprises an industry standard screw threading and said sliding member is screwed on to said microphone boom before it is slid into said slot, an advantageous embodiment of the present invention is obtained.

When said sliding member forms part of an adapter according to any of the above, an advantageous embodiment of the present invention is obtained.

When said method comprises assembling an assembly according to any of the above, an advantageous embodiment of the present invention is obtained.

The present invention further relates to a method of mounting a microphone boom 10, 20 on a support 26, 120, said microphone boom comprising a socket 30 with inside threading 31 and said support comprising a sliding slot 50, said method comprising the steps of screwing a threaded pin 41 of an adapter 40 into said socket and sliding a base 42 of said adapter 40 into said sliding slot 50.

When said method further comprises the step of engaging a further locking mechanism 70, 100, 150, 160, an advantageous embodiment of the present invention is obtained.

When said further locking mechanism is automatically engaged, an advantageous embodiment of the present invention is obtained.

When said further locking mechanism is manually engaged, an advantageous embodiment of the present invention is obtained.

When said adapter comprises an adapter according to any of the above, an advantageous embodiment of the present invention is obtained.

present invention further relates to a system comprising a microphone boom 10, 20 and a support 26, 120, wherein said microphone boom is fitted to said support by means of a slide and lock engagement 40, 50, 70, 100, 150, 160, an advantageous embodiment of the present invention is obtained.

When said slide and lock engagement is releasable, an advantageous embodiment of the present invention is obtained.

When said support comprises a microphone stand, an advantageous embodiment of the present invention is obtained.

When said microphone boom is fitted to a monitor positioned on said support, an advantageous embodiment of the present invention is obtained.

When said slide and lock engagement comprises an adapter according to any of the above, an advantageous embodiment of the present invention is obtained.

When said system comprises an assembly according to any of the above, an advantageous embodiment of the present invention is obtained.

The present invention further relates to a support 26, 120 comprising a mount 50 for mounting a microphone boom 10, 20, wherein said mount comprises a sliding slot 50.

When said support comprises a monitor 26, 120, an advantageous embodiment of the present invention is obtained.

When said sliding slot is designed to cooperate with a base 42 of an adapter 40 for enabling mounting of an industry standard microphone boom mount, an advantageous embodiment of the present invention is obtained.

When said support further comprises a further locking arrangement 70, 100, 150, 160, an advantageous embodiment of the present invention is obtained.

When said adapter comprises an adapter according to any of the above, an advantageous embodiment of the present invention is obtained.

When said sliding slot enables mounting of a microphone boom according to the methods of any of the above, an advantageous embodiment of the present invention is obtained.

### THE DRAWINGS

In the following, the invention will be described with reference to the drawings where

FIG. 1 illustrates a conventional microphone stand,

FIG. 2 illustrates an embodiment of the present invention,

FIG. 3 illustrates a conventional microphone boom mount,

FIG. 4A-4B illustrate an adapter according to the present invention,

FIG. 5A-5B illustrate an embodiment of the present invention,

FIG. 6A-6C illustrate an embodiment of the present invention,

FIG. 7A-7C illustrate an embodiment of the present invention,

FIG. 8A-8C illustrate an embodiment of the present invention,

FIG. 9 illustrates an embodiment of the present invention,

FIG. 10 illustrates an embodiment of the present invention,

FIG. 11A-11B illustrate an embodiment of the present invention,

FIG. 12 illustrates an embodiment of the present invention,

FIG. 13 illustrates an embodiment of the present invention,

FIG. 14 illustrates an embodiment of the present invention,

FIG. 15A-15C illustrate an embodiment of the present invention, and

FIG. 16A-16C illustrate an embodiment of the present invention.

### DETAILED DESCRIPTION

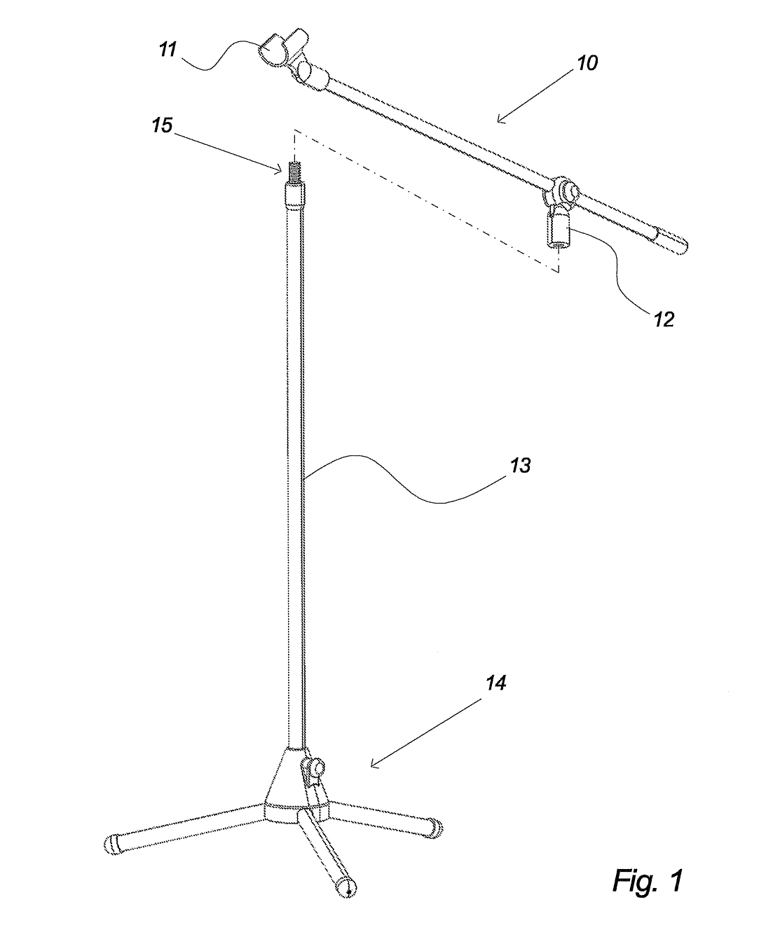

FIG. 1 illustrates a conventional, extremely common microphone stand. It comprises a microphone boom 10, comprising a microphone mount 11 and a boom mount 12. The stand further comprises a vertical shaft 13 supported by a base, e.g. a tripod, 14. It further comprises a threaded upper end 15 corresponding to the threaded socket of the boom mount 12. When assembling the microphone stand, the shaft is typically lifted and screwed up into the boom mount socket. If the shaft is fixated, the boom has to be turned round and round which is inconvenient in most cases.

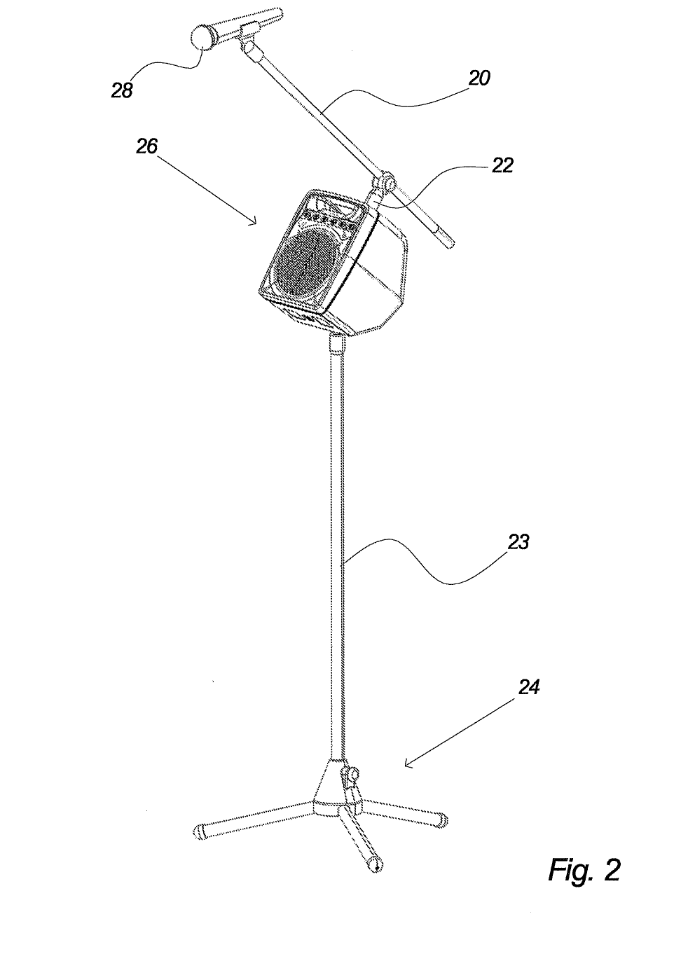

FIG. 2 illustrates an application of a standard microphone boom 20 with a standard boom mount 22 and a microphone 28 to an audio monitor 26 mounted on top of a shaft 23 supported by a tripod 24. This is an example of an application where it would be inconvenient to have to lift the stand and audio monitor and turn them round and round for screwing a screw mounted on the monitor into the boom mount 22, and where it is also inconvenient, as described above, to turn the microphone boom 20 round and round.

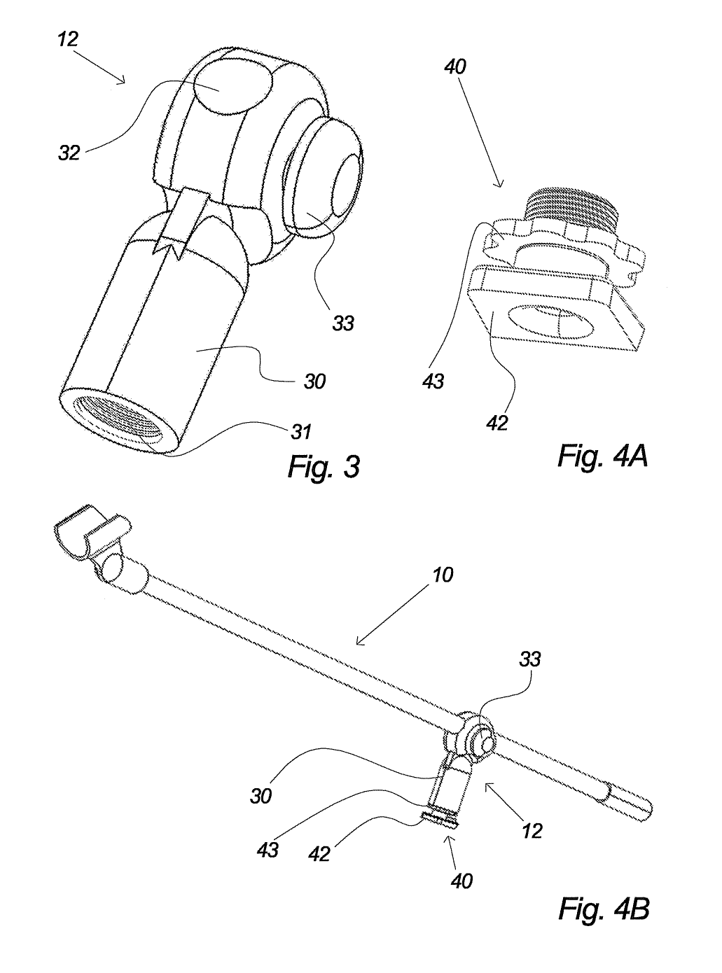

FIG. 3 comprises a more detailed view of a conventional microphone boom mount 12, comprising a socket 30 with a thread on the inner side and a mount for the boom 32 with a fastening means 33.

FIG. 4A illustrates an adapter 40 according to a preferred embodiment of the present invention. It comprises a threaded pin 41, preferably with a thread corresponding to conventional microphone boom mounts, i.e. either the North American standard or the European standard. Further, it comprises a base 42 suitable for sliding into a sliding slot of corresponding kind, i.e. the base 42 should comprise a flange, a protruding edge, one or more protruding pins, or other means for allowing the adapter to slide into a sliding slot. The embodiment of FIG. 4 further comprises a lock nut 43 for fastening the microphone boom mount in a certain direction relative to the adapter base 42, which preferably is edged as opposed to round. The lock nut preferably comprises finger holds to facilitate easy use without need of tools. An alternative embodiment of the invention does, however, not comprise a lock nut. A further alternative embodiment of the present invention comprises a round base 42, thus allowing the adapter to be rotated when fitted into the sliding slot, thereby allowing rotation of the microphone boom mounted thereon.

According to a preferred embodiment of the present invention, the threaded pin 41 of the adapter 40 is screwed into the socket 30 of the microphone boom mount 12, thereby providing the microphone boom mount with a slidable mount instead of the conventional screw mount. It is noted that the scale of FIG. 4 does not correspond to the scale of FIG. 3. Hence, in a preferred embodiment, the threaded pin 41 of the adapter 40 has a diameter and a threading that correspond to the inner diameter and threading of the microphone boom mount it should be used with, preferably one of the two industry standard threadings, i.e. the North American or the European, as described above.

FIG. 4B illustrates a microphone boom 10 and its corresponding conventional mount 12 being mounted on the adapter 40 by means of the threaded pin 41 and preferably the lock nut 43. When the microphone boom is provided with an adapter according to the present invention as illustrated in FIG. 4B it may conveniently be mounted on a support that comprises a corresponding sliding slot.

It is noted that in the following, the adapter is shown in different mountings without the microphone boom mount 12. This mount has been removed due to clarity, and in any practical use, the microphone boom mount should preferably be mounted on the adapter by the screw mount prior to sliding the adapter into position in the sliding slot.

An embodiment of the invention may be applied in a microphone stand application as described in PCT/DK2005/000645, hereby incorporated by reference.

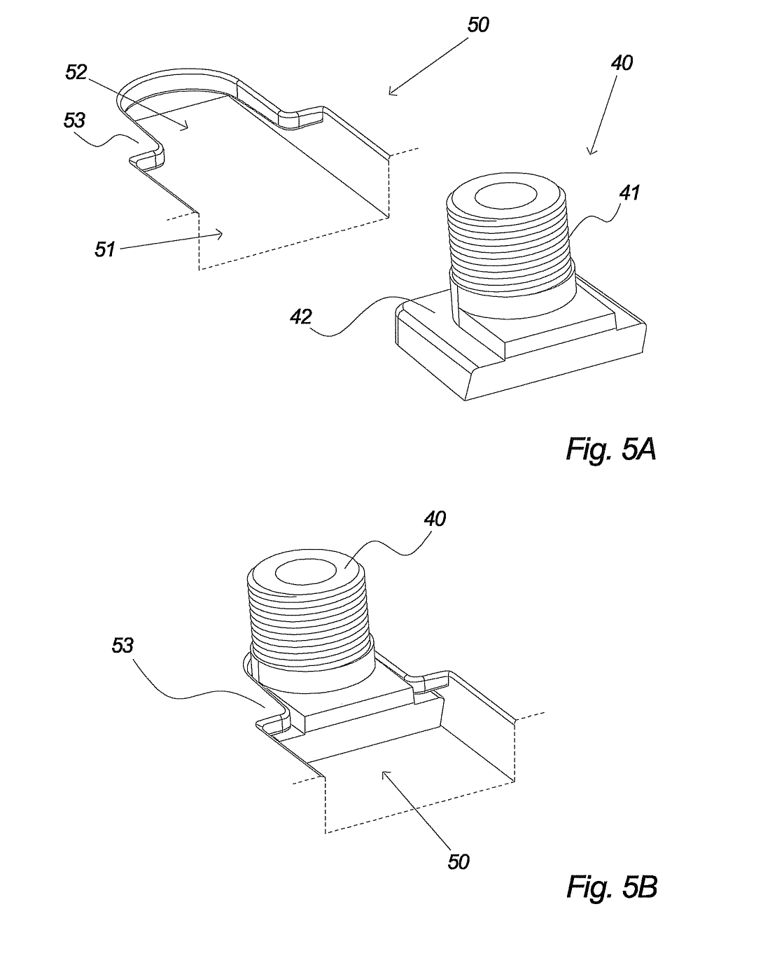

FIG. 5A illustrates how the adapter 40 may be engaged with a sliding slot 50. The sliding slot comprises a first opening 51, allowing the adapter 40 to be inserted from a suitable direction. In FIG. 5A, the adapter 40 may be inserted either vertically or horizontally. By changing the design of the first opening 51, the sliding slot may be restricted to more specific insertion methods. The sliding slot further comprises a second opening 52, partly covered by flanges 53 at a certain distance above the bottom of the second opening. These flanges 53 cooperate with the base 42 of the adapter 40, thus causing the adapter to be fixed in several directions when inserted into the slot. FIG. 5B illustrates the adapter being finally fitted into the sliding slot. With the embodiment of this example, there is only one direction in which the adapter can be moved freely. Hence, an almost complete fixation of the adapter is obtained by a very simple and convenient slide procedure, not requiring rotating long objects, lifting heavy objects, etc.

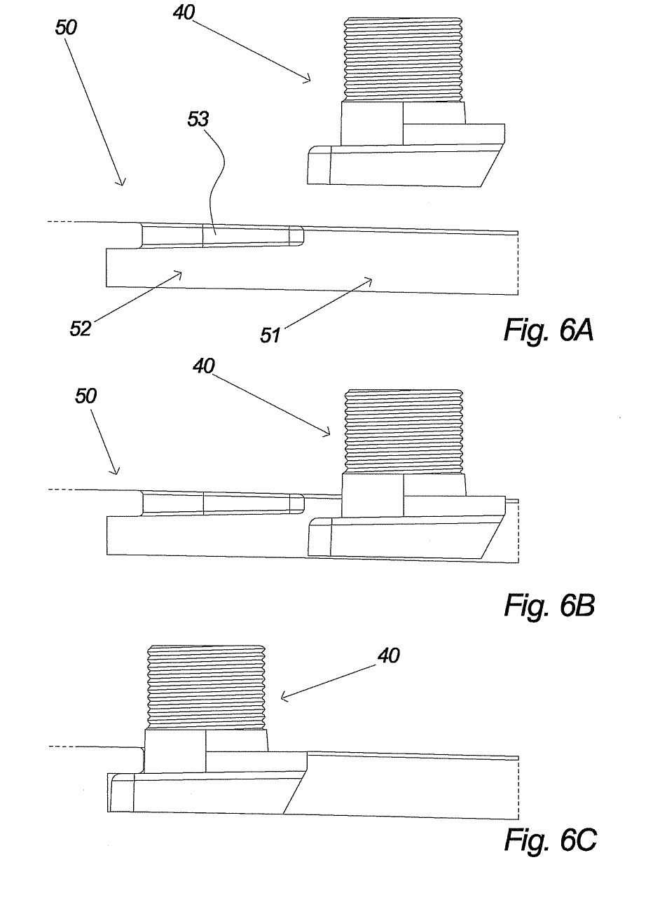

FIGS. 6A to 6C illustrate the insertion of an embodiment of an adapter 40 according to the present invention into a sliding slot 50 corresponding to the sliding slot shown in FIGS. 5A-5B but here as seen from the side. From FIG. 6A to 6B, the adapter is lowered into the first broad opening 51 of the sliding slot 50. From FIG. 6B to 6C, the adapter is slid into the second fixating opening 52 of the sliding slot.

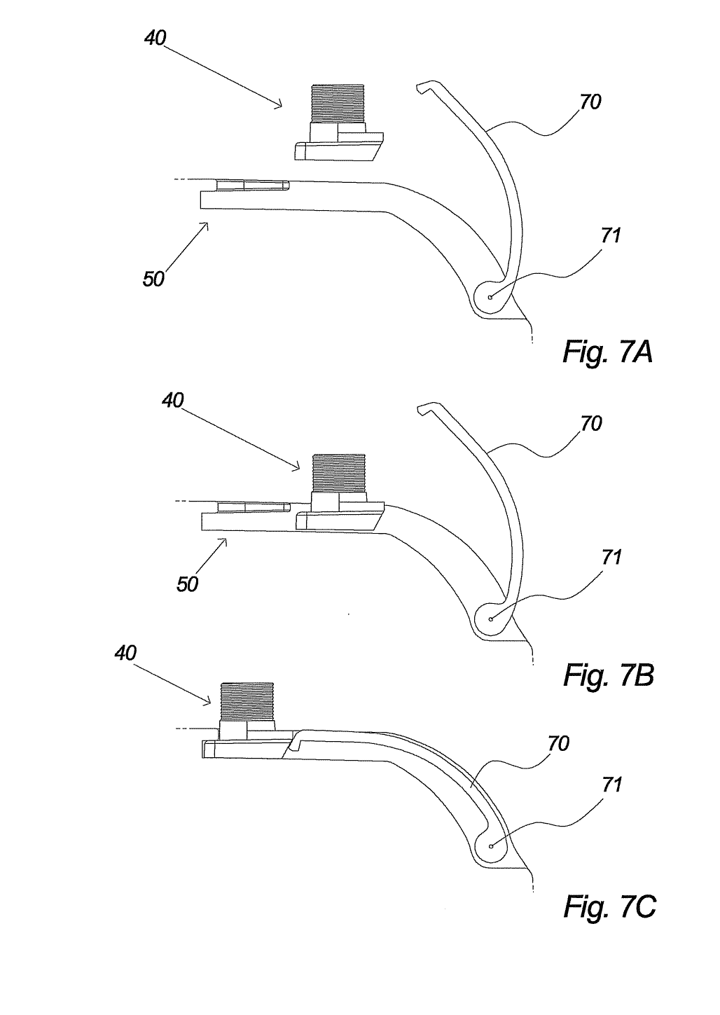

FIGS. 7A to 7C illustrate an improvement of the embodiment of FIGS. 5A-5B and 6A-6C. In addition to a sliding slot 50 and an adapter 40 according to an embodiment of the present invention, the embodiment of FIGS. 7A-7C further comprises a pivoting lid 70 which may be pivoted around an axis 71. When inserting the adapter into the sliding slot 50, the lid should be pivoted away from the first opening of the sliding slot, thereby enabling access to the first opening. When the adapter is inserted and slid into the sliding slot, the lid should be pivoted back into the first opening, thereby removing the possibility of removing the adapter the way it was inserted, which is the only free movable direction of the embodiment of FIGS. 5A-6C. The lid 70 should preferably be provided with a spring to ensure that it automatically pivots back into the first opening of the sliding slot. In order to remove the adapter, the lid should be pivoted away, the adapter removed, and the lid put back.

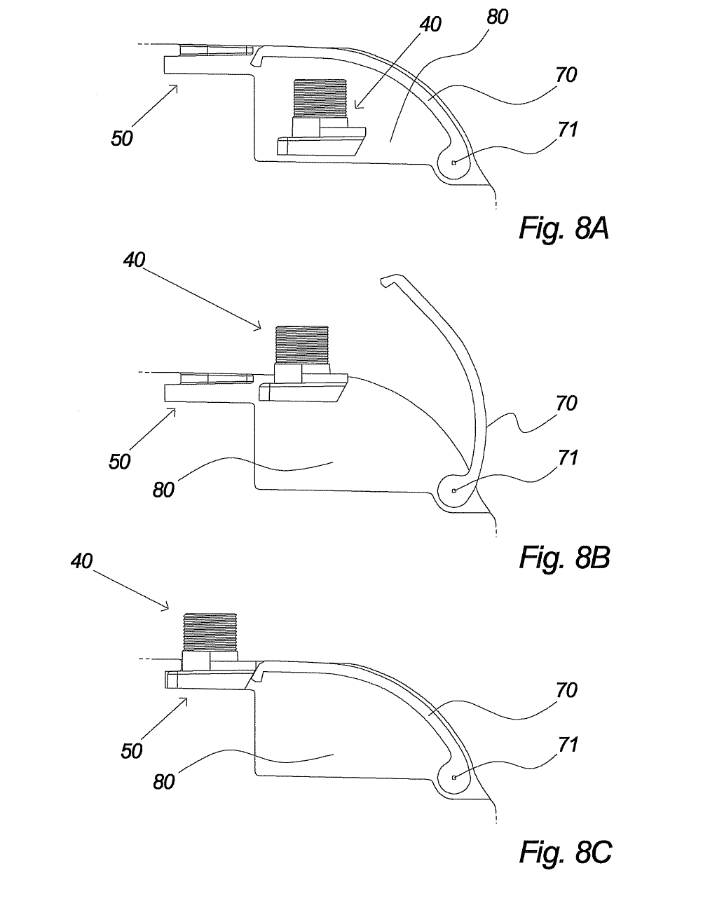

FIG. 8A to 8C illustrate a preferred embodiment of the present invention. It comprises a sliding slot 50 and a lid 70 that may be pivoted around an axis 71. Regarding insertion and removal of the adapter, it works as described above regarding FIGS. 6A-6C. The embodiment of FIGS. 8A-8C, however, further comprises a compartment 80 covered by the lid 70 wherein the adapter 40, and possibly other stuff, may be kept when not in use, thereby ensuring that the adapter is always within reach when needed. Furthermore, the compartment may be used for keeping a spare adapter in case the first adapter disappears or is ruined.

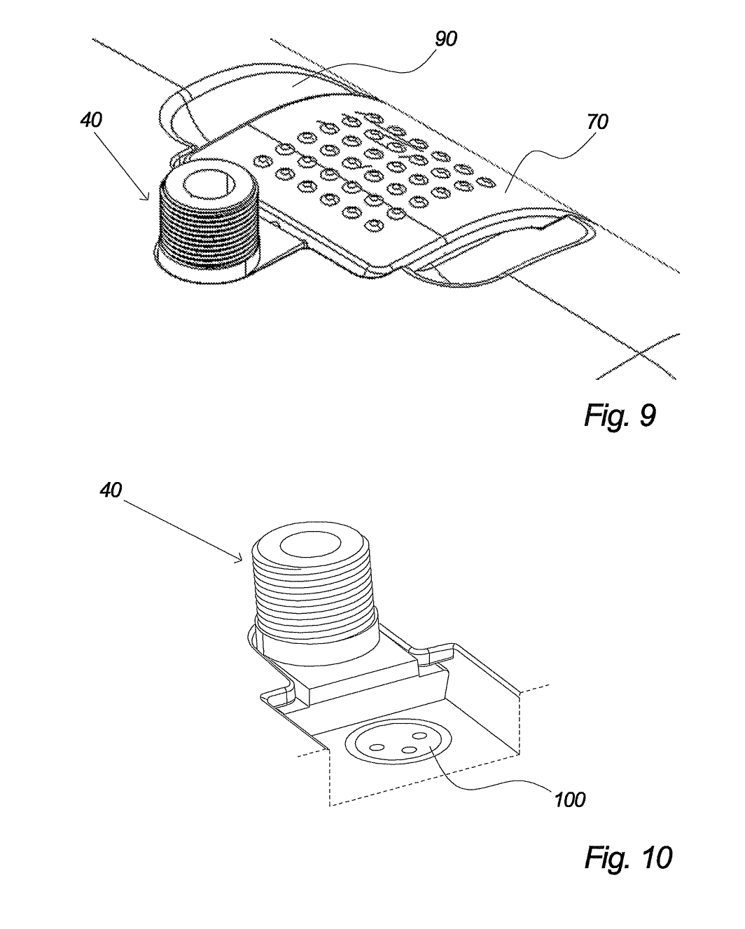

FIG. 9 illustrates a perspective view of an embodiment, e.g. according to FIGS. 7A-7C or 8A-8C. It comprises a sliding slot wherein an adapter 40 according to the present invention is mounted. The adapter is kept into place by a lid 70. Finger suitable cavities 90 in the body surrounding the lid facilitate easy handling of the preferably spring-loaded lid, i.e. pivoting, by the user.

FIG. 10 illustrates an alternative locking mechanism for removing the one free movable direction when the adapter is fixated in the sliding slot. In the bottom of the first opening of the sliding slot, a socket or hole suitable for receiving a plug of corresponding kind is provided. When the present invention is used for mounting a microphone boom upon an audio monitor or other audio equipment that may make use of the microphone signal anyway, a preferred kind of socket may be an XLT female socket for receiving the XLT plug usually used for the microphone cable. In other fields, the socket and plug may be jack plugs, phono plugs, data plugs, etc. When the plug is inserted, the adapter is completely fixated and cannot be removed without first removing the plug.

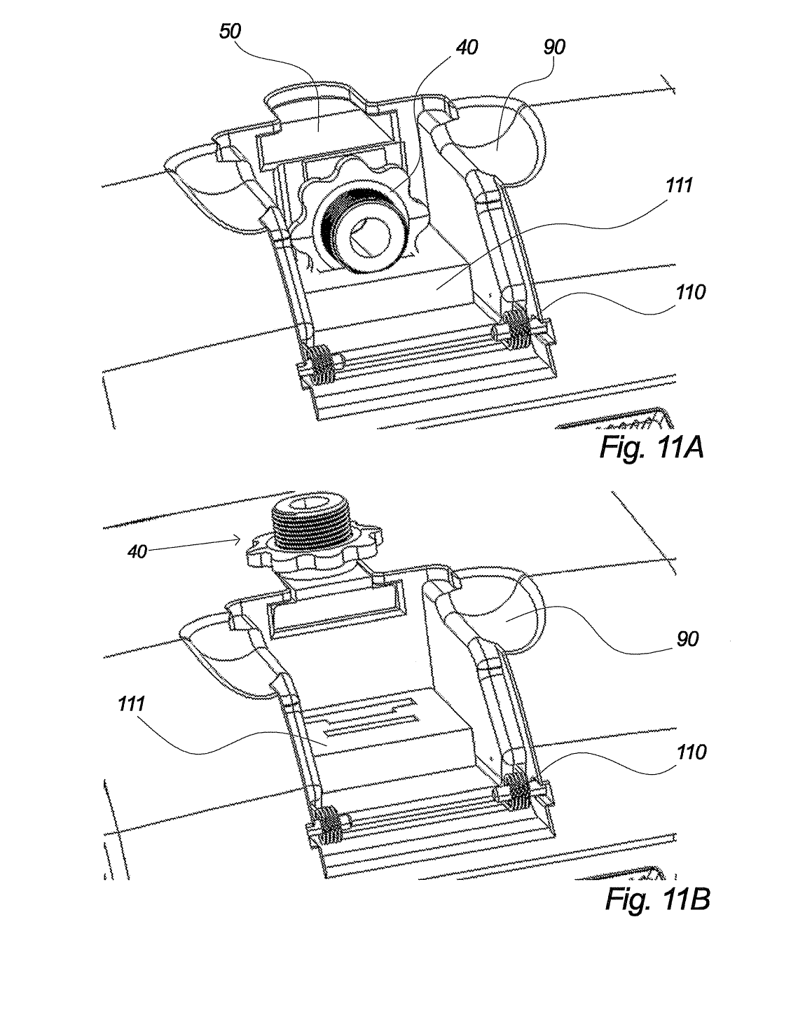

FIGS. 11A and 11B comprise further illustrations of a preferred embodiment of the present invention. Due to clarity, the lid is not shown, even though forming part of the embodiment. FIG. 11A comprises a spare adapter or at least an unused adapter 40 positioned in the compartment 80. In order to avoid noise and the adapter slipping out during handling, a suitably cut piece of foam 111 or other suitable means is provided for fixating the adapter 40. FIG. 11A further illustrates a couple of springs 110 for use with the lid 70 and the cavities 90.

FIG. 11B illustrates the adapter 40 removed from the foam 111 and instead slid into the sliding slot 50.

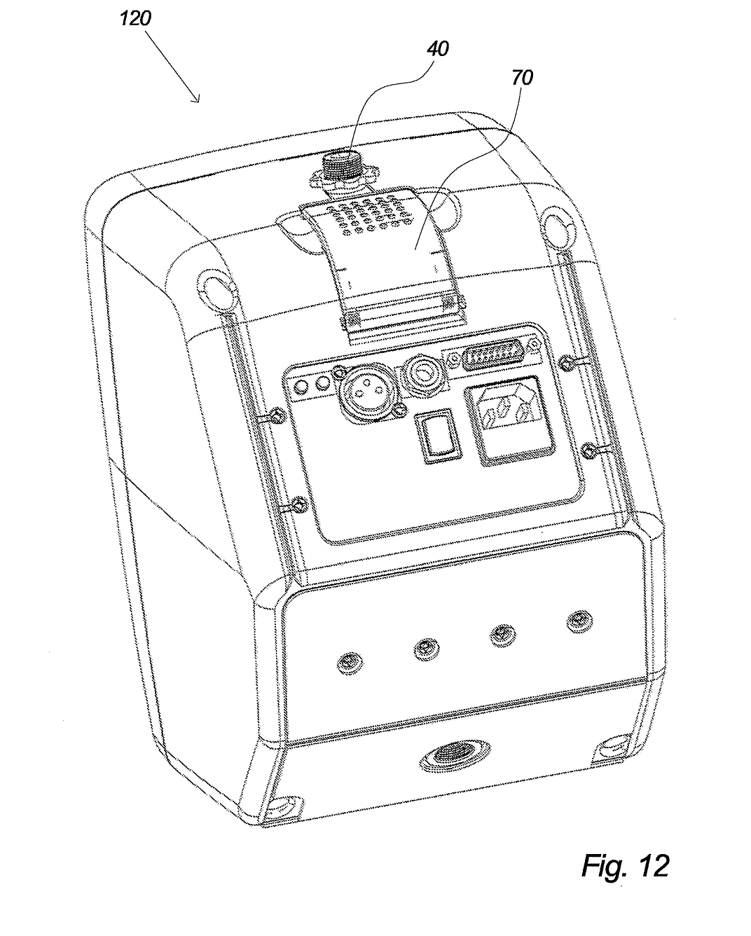

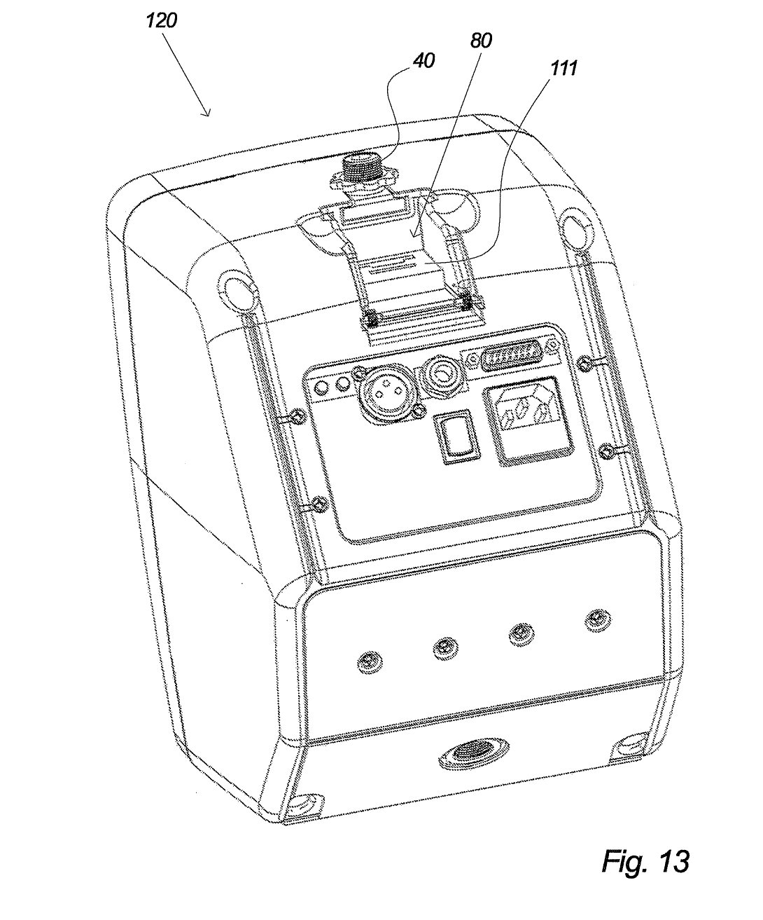

FIG. 12 illustrates a preferred embodiment of the present invention. It comprises an audio monitor, seen from the back, whereon an adapter 40 according to the present invention is fixated by the convenient slide and lock method of the present invention. It is secured by a lid 70. FIG. 13 corresponds to FIG. 12, but the lid 70 has been removed due to clarity, thereby exposing the compartment 80 and the foam 111.

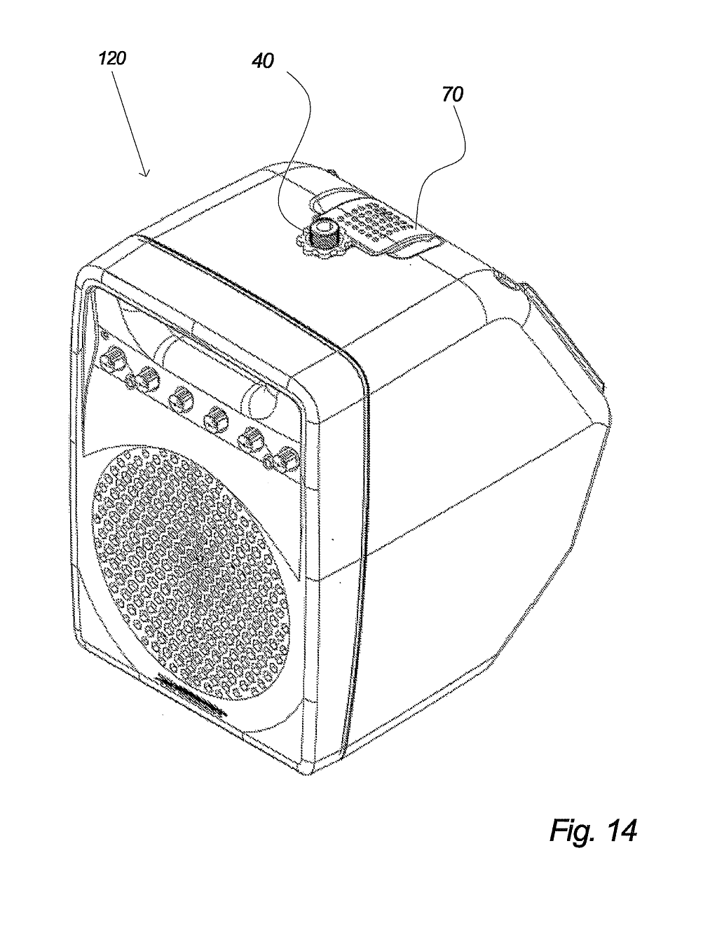

FIG. 14 illustrates the audio monitor 120 of FIGS. 12 and 13 seen from the front. At the top of the monitor, the adapter 40 is securely fixated by the sliding slot and the lid 70.

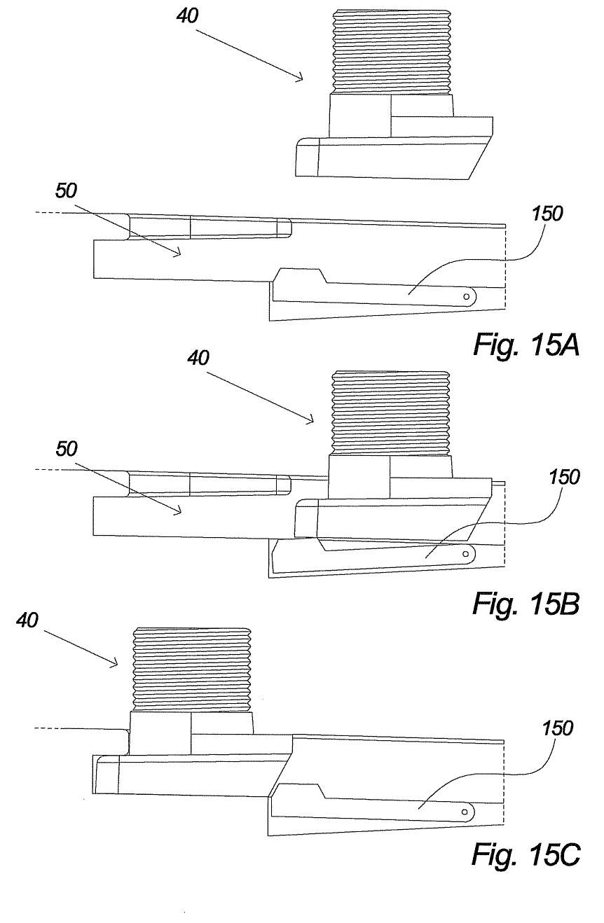

FIGS. 15A-15C illustrate a locking method alternative to the lid 70 described above. It comprises a locking arm 150 that is spring-loaded, either by means of a suitable kind of spring or by being produced or fastened in a springy fashion. The locking arm partly covers the opening into the sliding slot 50, but the locking arm may be depressed into a cavity when needed, thereby allowing the adapter 40 to be slid into place. When the adapter is completely within the second opening of the sliding slot 50, the locking arm is released and pops back into the position where it covers the opening. Thereby, the adapter is securely fixated within the sliding slot.

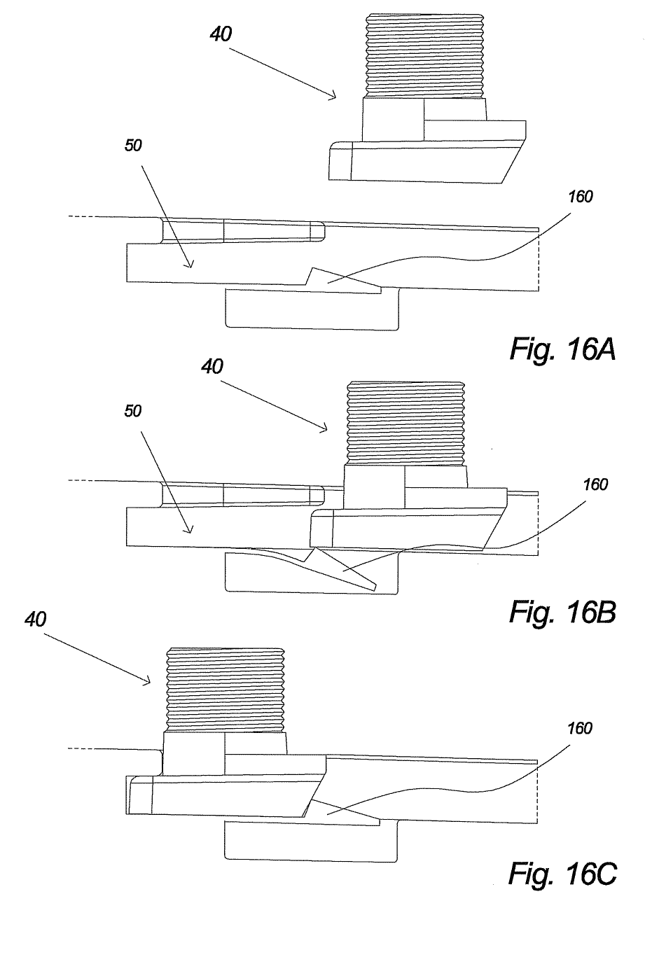

FIG. 16A to 16C illustrates an alternative embodiment of the embodiment of FIGS. 15A-15C. It also works by providing a locking arm that may be removed from the opening during insertion or removal of the adapter, but which securely locks the adapter when not affected.

In an alternative embodiment, not shown, the lock nut 43 of the adapter 40 is screwed further down into the threaded pin 41 when the adapter is positioned in the sliding slot, instead of up against the microphone boom mount. Thereby, the lock nut cooperates with the adapter base 42 in squeezing the flange 53 of the sliding slot 50. The adapter is thereby securely fastened to the flange 53 and cannot be removed without loosening the lock nut. In an alternative embodiment, the adapter is provided with two lock nuts, one for fastening the microphone boom mount and one for locking the adapter when slid into the sliding slot.

It is noted that within the scope of the present invention, several locking mechanisms can be provided to lock the adapter into position inside the sliding slot. The locking mechanism may be divided into passive locking mechanisms which require the user to slide the adapter into position and then do a further action, e.g. open and close a lid, insert a plug into a socket, etc., and active locking mechanisms which automatically engage when the adapter is slid into the sliding slot, e.g. the embodiments of FIGS. 15A-15C and 16A-16C.

1. Adapter comprising a threaded pin and a base, wherein said threaded pin comprises a threading corresponding to an industry standard microphone boom mount threading.

2. Adapter according to claim 1, wherein said base fits within a sliding slot of a support.

3. Adapter according to claim 1, wherein said base fits within said sliding slot of said support in a sliding manner.

4. Adapter according to claim 1, wherein said support comprises a monitor.

5. Adapter according to claim 1, wherein said support comprises a microphone stand.

6. Adapter according to claim 1, wherein said adapter comprises a lock nut.

7. Adapter according to claim 1, wherein said base is edged.

8. Adapter according to claim 1, wherein said base is round.

9. Adapter according to claim 1, wherein said adapter is a microphone boom mount adapter.

10. Adapter according to claim 1, wherein said adapter is provided together with said support.

11. An assembly comprising a microphone boom and a support, wherein said assembly is assembled by a sliding-slot and a corresponding mechanical arrangement fitting into said sliding slot by a sliding movement between said microphone boom and said support, and wherein said assembly further comprises a further mechanical releasable lock arrangement for mutual fixation of said microphone boom and said support in the slide direction of said sliding slot.

12. An assembly according to claim 11, wherein said slide direction is the longitudinal direction of said sliding slot.

13. An assembly according to claim 11, wherein said sliding slot is comprised by said microphone boom.

14. An assembly according to claim 11, wherein said sliding slot is comprised by said support.

15. An assembly according to claim 11, wherein said further mechanical releasable lock arrangement is comprised by said microphone boom.

16. An assembly according to claim 11, wherein said further mechanical releasable lock arrangement is comprised by said support.

17. An assembly according to claim 11, wherein said support forms part of a microphone stand.

18. An assembly according to claim 11, wherein said support forms part of a monitor.

19. An assembly according to claim 11, wherein said monitor is mounted on top of a microphone stand.

20. An assembly according to claim 11, wherein said support comprises a monitor.

21. An assembly according to claim 11, wherein said corresponding mechanical arrangement fitting into said sliding slot is integrated with said microphone boom.

22. An assembly according to claim 11, wherein said corresponding mechanical arrangement fitting into said sliding slot forms part of an adapter which is releasably attached to said microphone boom, and wherein said microphone boom comprises a conventional microphone boom.

23. An assembly according to claim 11, wherein said corresponding mechanical arrangement fitting into said sliding slot comprises a threaded pin.

24. An assembly according to claim 11, wherein said threaded pin comprises industry standard microphone mount threading.

25. An assembly according to claim 11, wherein said corresponding mechanical arrangement fitting into said sliding slot comprises an edged base.

26. An assembly according to claim 11, wherein said sliding-slot comprises a flange which may cooperate with said corresponding mechanical arrangement.

27. An assembly according to claim 11, wherein said further mechanical releasable lock arrangement comprises an automatically engaging lock.

28. An assembly according to claim 11, wherein said further mechanical releasable lock arrangement comprises a manually engaged lock.

29. An assembly according to claim 11, wherein said further mechanical releasable lock arrangement comprises a pivotal lid.

30. An assembly according to claim 11, wherein said lid is spring-loaded.

31. An assembly according to claim 11, wherein said further mechanical releasable lock arrangement comprises a socket and plug arrangement.

32. An assembly according to claim 11, wherein said further mechanical releasable lock arrangement comprises a spring-loaded clip or locking arm.

33. An assembly according to claim 11, wherein said support comprises a compartment suitable for receiving said corresponding mechanical arrangement fitting into said sliding slot.

34. An assembly according to claim 11, wherein said further mechanical releasable lock arrangement forms part of said compartment.

35. An assembly according to claim 11, wherein said assembly can be disassembled.

36. An assembly according to claim 11, wherein said corresponding mechanical arrangement fitting into said sliding slot comprises an adapter comprising a threaded pin and a base, wherein said threaded pin comprises a threading corresponding to an industry standard microphone boom mount threading.

37. Method of mounting a microphone boom to a support, whereby said microphone boom or said support comprises a sliding member which is slid into a slot of the other part and locked by a further locking mechanism.

38. Method of mounting a microphone boom to a support according to claim 37, wherein said sliding member is comprised by said microphone boom.

39. Method of mounting a microphone boom to a support according to claim 37, wherein said sliding member is comprised by said support.

40. Method of mounting a microphone boom to a support according to claim 37, wherein said microphone boom comprises an industry standard screw threading and said sliding member is screwed on to said microphone boom before it is slid into said slot.

41. Method of mounting a microphone boom to a support according to claim 37, wherein said sliding member forms part of an adapter comprising a threaded pin and a base, wherein said threaded pin comprises a threading corresponding to an industry standard microphone boom mount threading.

42. Method of mounting a microphone boom to a support according to claim 37, wherein said method comprises assembling an assembly comprising a microphone boom and a support, wherein said assembly is assembled by a sliding-slot and a corresponding mechanical arrangement fitting into said sliding slot by a sliding movement between said microphone boom and said support, and wherein said assembly further comprises a further mechanical releasable lock arrangement for mutual fixation of said microphone boom and said support in the slide direction of said sliding slot.

43. Method of mounting a microphone boom to a support, said microphone boom comprising a socket with inside threading and said support comprising a sliding slot, said method comprising the steps of screwing a threaded pin of an adapter into said socket and sliding a base of said adapter into said sliding slot.

44. Method of mounting a microphone boom to a support according to claim 43, whereby said method further comprises the step of engaging a further locking mechanism.

45. Method of mounting a microphone boom to a support according to claim 43, whereby said further locking mechanism is automatically engaged.

46. Method of mounting a microphone boom to a support according to claim 43, whereby said further locking mechanism is manually engaged.

47. Method of mounting a microphone boom to a support according to claim 43, whereby said adapter comprises an adapter comprising a threaded pin and a base, wherein said threaded pin comprises a threading corresponding to an industry standard microphone boom mount threading.

48. System comprising a microphone boom and a support, wherein said microphone boom is fitted to said support by means of a slide and lock engagement.

49. System comprising a microphone boom and a support according to claim 48, wherein said slide and lock engagement is releasable.

50. System comprising a microphone boom and a support according to claim 48, wherein said support comprises a microphone stand.

51. System comprising a microphone boom and a support according to claim 48, wherein said microphone boom is fitted to a monitor positioned on said support.

52. System comprising a microphone boom and a support according to claim 48, wherein said slide and lock engagement comprises an adapter comprising a threaded pin and a base, wherein said threaded pin comprises a threading corresponding to an industry standard microphone boom mount threading.

53. System comprising a microphone boom and a support according to claim 48, wherein said system comprises an assembly comprising a microphone boom and a support, wherein said assembly is assembled by a sliding-slot and a corresponding mechanical arrangement fitting into said sliding slot by a sliding movement between said microphone boom and said support, and wherein said assembly further comprises a further mechanical releasable lock arrangement for mutual fixation of said microphone boom and said support in the slide direction of said sliding slot.

54. Support comprising a mount for mounting a microphone boom, wherein said mount comprises a sliding slot.

55. Support according to claim 54, wherein said support comprises a monitor.

56. Support according to claim 54, wherein said sliding slot is designed to cooperate with a base of an adapter for enabling mounting of an industry standard microphone boom mount.

57. Support according to claim 54, wherein said support further comprises a further locking arrangement.

58. Support according to claim 54, wherein said adapter comprises an adapter comprising a threaded pin and a base, wherein said threaded pin comprises a threading corresponding to an industry standard microphone boom mount threading.

59. Support according to claim 54, wherein said sliding slot enables mounting of a microphone boom according to a method of mounting a microphone boom to a support, whereby said microphone boom or said support comprises a sliding member which is slid into a slot of the other part and locked by a further locking mechanism.

60. Support according to claim 54, wherein said sliding slot enables mounting of a microphone boom according to a method of mounting a microphone boom to a support, said microphone boom comprising a socket with inside threading and said support comprising a sliding slot, said method comprising the steps of screwing a threaded pin of an adapter into said socket and sliding a base of said adapter into said sliding slot.
